(19) United States
(12) Patent Application Publication
(10) Pub. No.: US 2015/0075306 A1
(43) Pub. Date: Mar. 19, 2015

(54) TELESCOPING LINEAR ACTUATOR WITH SCREW DRIVES

(71) Applicants: Peter M. Castelli, Patchogue, NY (US); Anthony Jack Giannetto, Centereach, NY (US)

(72) Inventors: Peter M. Castelli, Patchogue, NY (US); Anthony Jack Giannetto, Centereach, NY (US)

(73) Assignee: Thomson Industries, Inc., Marengo, IL (US)

(21) Appl. No.: 14/383,650

(22) PCT Filed: Mar. 8, 2012
(86) PCT No.: PCT/US12/28216

§ 371 Date: Sep. 8, 2014

(51) Int. Cl. F16H 25/20; F16H 25/24

(52) U.S. Cl. CPC F16H 25/20; F16H 25/2454; F16H 2025/2081
USPC 74/89.35

(57) ABSTRACT

A linear actuator (20) including three nested telescoping sections (22, 24, 26) actuated by two internal screw drives (28, 30). First and second screw drive nuts (32, 34) are rotatably mounted in the intermediate telescoping section (24) to linearly translate respective first and second screw shafts (36, 38), which are fixed to respective distal ends (21, 27) of the outer (22) and inner (26) telescoping sections. The drive nuts may be mounted at opposite ends of the intermediate section in a housing (23, 25, 29), and may be driven by a motor (40) therein via an idler shaft (42) that spans between the two drive nuts. The motor may be designed to serve alternately as a regenerative resistance brake (R1). A mechanical brake (43) may alternately or additionally be provided. Either or both brakes may be set to engage by default on power outage.

### FIELD OF THE INVENTION

This invention relates to telescoping linear actuators, and particularly one with three telescoping sections actuated by two internal screw shafts linearly translated in opposite directions by drive nuts rotated by an internal motor.

### BACKGROUND OF THE INVENTION

A linear actuator is a device that extends along a straight line to provide mechanical force to operate a variable apparatus. Among other applications, a linear actuator can support any lift application that requires controlled vertical motion in a compact envelope, such as medical lifts, packaging applications, and material processing. For example, a vertical actuator may be provided in a hospital gurney to lift and lower the mattress plane with a patient thereon. Telescoping actuators have two or more nested sections that telescopically extend and retract under control of an actuating mechanism such as a hydraulic piston or motor-driven screw drive. One such actuator is described in U.S. Pat. No. 6,026,970. One measure of an actuator design is its extended-to-retracted length ratio. Higher ratios are better for space efficiency. Other measures include energy efficiency, cost, noise, reliability, and safety, including prevention of unintended retraction or collapse of the loaded actuator during a power failure. However, it is difficult to maximize all of these measures concurrently in a single design.

### BRIEF DESCRIPTION OF THE DRAWINGS

The invention is explained in the following description in view of the drawings that show:

FIG. 1 is a perspective front view of a telescopic linear actuator in accordance with an embodiment of the invention and shown in an extended position.

FIG. 2 is a sectional view of the nested telescoping sections of FIG. 1.

FIG. 3 is a perspective rear view of the actuating mechanism of the telescopic linear actuator of FIG. 1 shown in a retracted position.

FIG. 4 is a top view of a mechanical brake in an embodiment of the invention.

FIG. 5 is a perspective rear view of the brake embodiment of FIG. 4.

FIG. 6 is a circuit diagram of a dynamic brake embodiment of the invention.

### DETAILED DESCRIPTION OF THE INVENTION

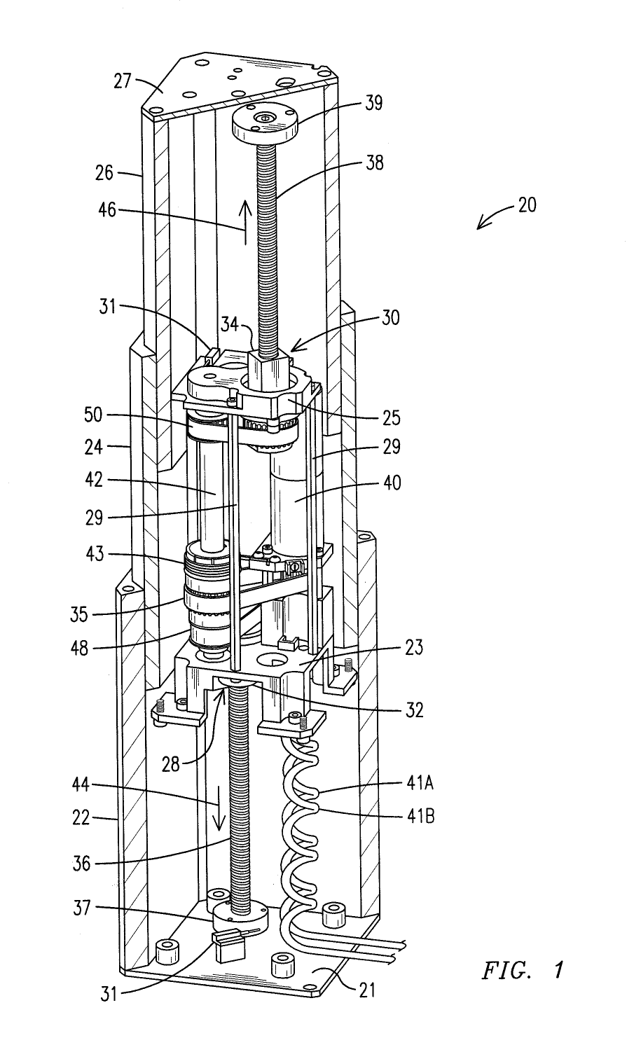

FIG. 1 shows a telescopic linear actuator 20 according to an embodiment of the invention, with three nested telescoping sections -- an outer section 22, an intermediate section 24, and an inner 26 section. The sections are actuated to telescopically extend and retract via two internal screw drives 28, 30 comprising two screw drive nuts 32, 34 mounted in thrust bearings in the intermediate telescoping section 24, and respective screw shafts 36, 38. The screw drives 28, 30 may be embodied as ball screw assemblies, in which ball bearings run in helical races between the drive nut 32, 34 and the respective screw shaft 36, 38, minimizing torque for a given axial force. The drive nuts 32, 34 are driven via an idler shaft 42 that spans between them and is driven by a reversible motor 40 mounted in the intermediate section 24, which is powered via power supply leads 41A, 41B. The motor 40 may include reduction gears. The top plate 27 of the outer section 22 may be attached to a hospital gurney or other weight to be lifted.

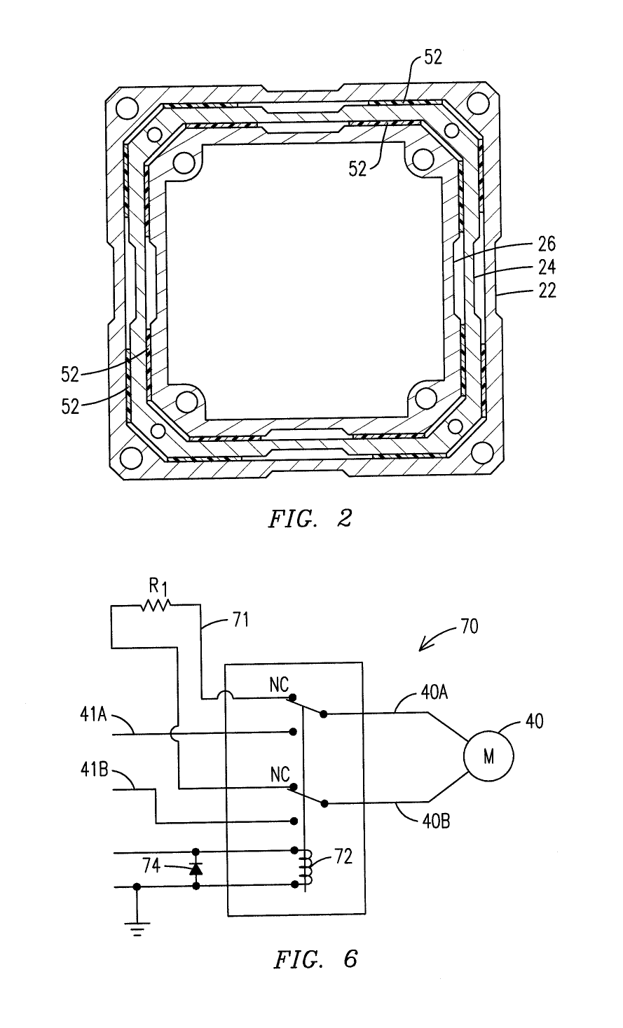

FIG. 2 shows a sectional view of the nested sections 22, 24, 26, which may be slidably spaced using polymer bearing pads 52.

FIG. 3 shows the actuating mechanisms of FIG. 1 in a retracted position. A housing 33 may be provided within the intermediate section 24 to support the actuator mechanisms. The housing may include a housing base 23 attached to the bottom end of the intermediate section 24, an upper support plate 25 at the top end of the intermediate section 24, and support rods 29 that support the upper support plate 25 from the housing base 23. The housing may not touch the intermediate section 24 except at the bottom end thereof, so that the upper telescoping section 26 can slide down over the housing and within the intermediate section 24 for retraction of the actuator 20. Limit switches and/or other travel position feedback devices 31 may be provided to sense the relative positions of the telescoping sections and/or to halt the motor at the limits of travel. For example, a small cluster gear providing a reduction ratio such as 12:1 may be used to sense movement of the actuating mechanism and to drive a potentiometer which provides an analog signal indicative of position over the entire stroke length.

The lower screw drive nut 32 may be rotatably mounted on the housing base 23. The lower or distal end of the lower screw shaft 36 may be attached non-rotatably to the bottom or distal end of the outer telescoping section 22 via a push plate 37 attached to a base plate 21 of the intermediate section 22 or by other means. The lower screw shaft 36 passes through the lower drive nut 32, and is linearly translated by rotation of the lower drive nut 32.

The upper screw drive nut 34 may be rotatably mounted on the upper support plate 25 at the top end of the intermediate section 24. The upper or distal end of the upper screw shaft 38 may be attached non-rotatably to the top or distal end of the inner telescoping section 26 via a push plate 39 attached to a top plate 27 of the intermediate section or by other means. The upper screw shaft 38 passes through the upper drive nut 34, and is linearly translated by rotation of the upper drive nut 34. The push plates 37, 39 transfer and distribute forces between the screw shafts 36, 38 and the respective base plate 21 and top plate 27.

One of the screw drives 28, 30 may be left-handed while the other one is right-handed, so that turning both drive nuts 32, 34 in the same direction translates the respective screw shafts 36, 38 in opposite directions 44, 46. This forces the outer telescoping section 22 and the inner section 26 in opposite directions relative to the intermediate section 24, extending the actuator 20. Because the two drive nuts 32, 34 turn in the same direction, they can each be driven by a simple pulley/belt drive 48, 50 at opposite ends of the idler shaft 42 as shown, rather than by gears. Belt drives can be quiet, accurate, and reliable. Some automotive timing belts are designed to last 100,000 miles. Alternately however, other transmission means such as gears or sprocket-and-chain drives may be used.

The idler shaft 42 may be mounted rotatably in the housing 33 in the intermediate section 24, and extends between the two drive nuts 32, 34. The motor 40 drives the idler shaft 42 via a belt drive 35 or other means. The Idler shaft in turn drives the drive nuts 32, 34. Rotating the idler shaft 42 in a first direction translates two screw shafts 36, 38 in opposite directions relative to the intermediate section 24, extending the outer section 22 and the inner section 26 in opposite directions relative to the intermediate section 24. Rotating the idler shaft 42 in the opposite direction retracts the inner 22 and outer 26 sections. A mechanical brake 43 may be provided as later described. The two screw shafts 36, 38 may both have the same diameter and length, thus having the same maximum force capacity and drive parameters except for handedness. This reduces engineering complexity and maximizes space efficiency.

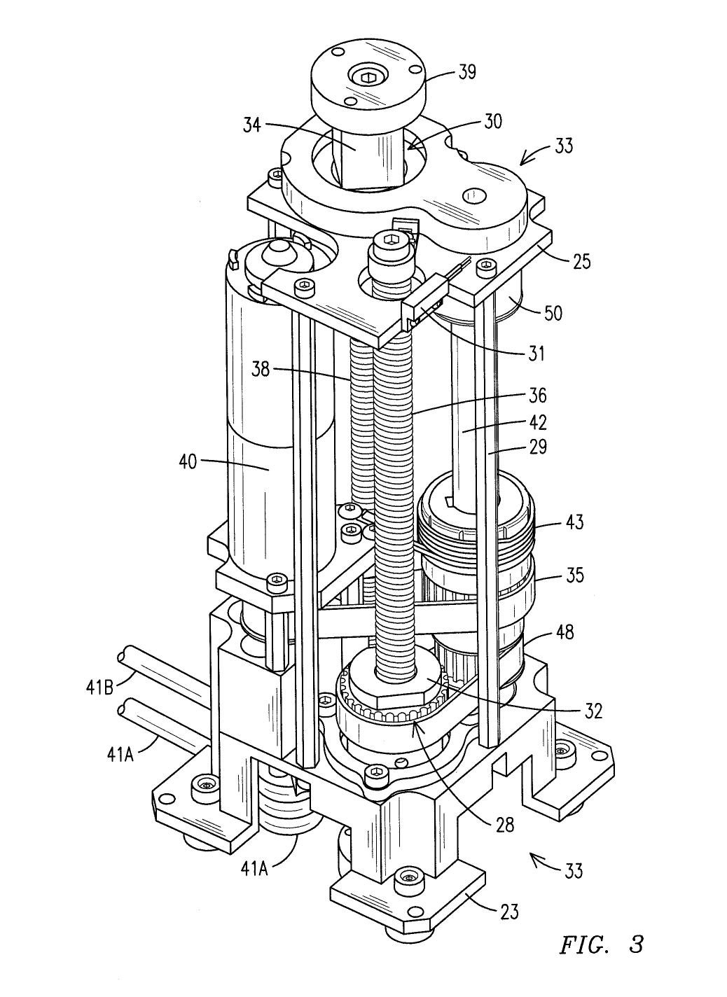

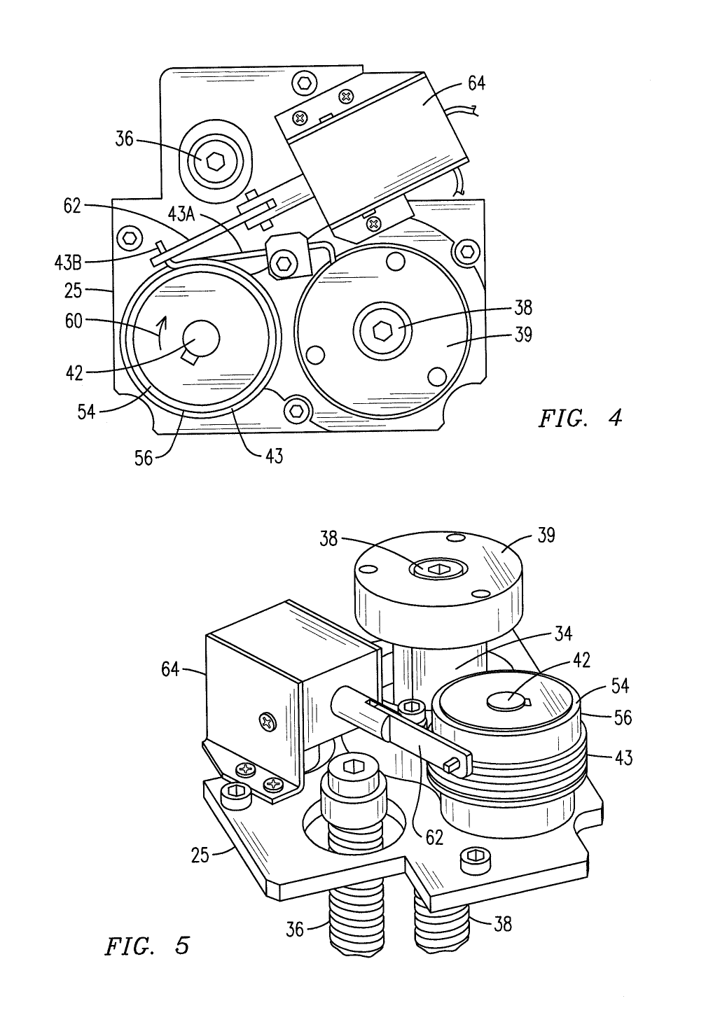

FIG. 4 shows an embodiment of a mechanical brake comprising a brake drum 54 with a cylindrical surface 56 mounted to the idler shaft 42 for co-rotation therewith. The brake drum may be located on an intermediate position of the idler shaft 42 as shown in FIGS. 1 and 3, or on an end of the idler shaft 42, such as the top end above the upper support plate 25, as shown in FIGS. 4 and 5. A brake spring 43 may be wrapped circumferentially around the cylindrical surface 56 of the brake drum 54. The brake spring 43 has a first end 43A that is fixed relative to the housing. For example, it may be fixed to the upper support plate 25. The spring 43 is wrapped around the cylindrical surface 56 of the brake drum 54 and has a second end 43B that is free to move with the cylindrical surface 56 of the brake drum 54. When the idler shaft 42 rotates in a direction 60 to extend the actuator 20, the cylindrical surface of the brake drum 54 rotates circumferentially away from the second end 43B of the brake spring 43 toward the first end 43A thereof, causing the second end 43B to move toward first end 43A, thereby loosening the brake spring 43 on the brake drum 54 so that it provides only slight drag and free rotation is achieved. Once motion has ceased, the spring diameter collapses around the brake drum 54 and provides friction which maintains the position of the idler shaft 42. When the lifted weight causes the idler shaft 42 to begin rotate to retract the actuator 20, the cylindrical surface of the brake drum 54 rotates the second end 43B of the brake spring 43 away from the first end 43A, thereby tightening the brake spring 43 on the brake drum 54 and causing the spring 43 to grab the cylindrical surface 56 of the brake drum 54, locking its rotation and preventing retraction or collapse. This braking occurs for example when power to the motor 40 is switched off after an extension operation, and the weight being lifted by the actuator 20 tries to collapse it.

Because the brake spring 43 operates to resist the collapse of the actuator 20 under the influence of gravity on the hospital gurney or other weight being lifted, it is necessary for the drive motor 40 to overcome the braking effect of the brake spring 43 when retraction of the actuator 20 is desired. Optionally, an electrically-operated brake release linkage 62 may be used in some embodiments to pull the second end 43B of the brake spring 43 away from the circumferential surface 56 of the brake drum 54 to release the spring 43 from the brake drum 54 when retraction of the actuator 20 is desired. This reduces the load on the motor 40 during downward movement. A solenoid 64 may operate the linkage 62 to release the brake spring 43 whenever the motor 40 is powered to retract the actuator 20. The brake 43 may default to the engaged (non-released) condition when the solenoid is inactive during a power failure, thus preventing collapse of the actuator during a power failure.

FIG. 6 shows a circuit 70 for an electromagnetic brake embodiment of the invention. When the motor 40 is inactive, its leads 40A, 40B are disconnected from the power supply leads 41A, 41B and are connected instead by default to a resistor R1 (“NC” means normally closed). The motor 40 then becomes a regenerative resistance brake that opposes turning of the idler shaft 42. When the motor is activated, a relay 72 disconnects the resistor circuit 71, and connects the power supply 41A, 41B to the motor 40. A fly-back diode 74 may be provided in the relay circuit to damp voltage spikes therein. In the circuit state shown, the motor 40 resists rotation of the idler shaft 42, thus braking collapse of the actuator. Both a mechanical brake 43 and an electromagnetic brake 70 may be provided so that when the motor is de-energized after a lifting operation, it immediately begins its dynamic braking function, and once motion has stopped, the spring brake immediately engages. Both types of brakes may engage by default during power failure, and the electromagnetic brake may contribute up to 35% of the overall braking capacity in some embodiments.

A linear actuator based on an embodiment of the present invention may have an extension to retraction ratio such as 2.5:1 or more, due to the space efficiency of the drive mechanisms. The two ball screw assemblies occupy and same plane in space and are driven in the same direction, yet extend in opposite directions, allowing the actuator to achieve a low retraction height. There is no requirement for a transmission to produce counter rotating shafts since the opposite hand configuration eliminates this need. The two-stage, belt drive, ball bearing supported transmission configuration supports quiet uniform motion by eliminating a requirement foe meshed gears. Among other applications, the actuator can support any lift application that requires controlled vertical motion in a compact envelope, such as medical lifts, packaging applications, and material processing. For example, a single vertical actuator may be provided in a hospital gurney to lift and lower the mattress plane with a patient thereon. In such application, the dynamic axial force capacity of the unit may be for example about 4400 N or about 1000 lbs, and the static axial support capacity may be for example about 5400 N or about 1200 lbs.

An advantage of rotating the drive nuts 32, 34 instead of rotating the screw shafts 36, 38 is a reduction in the number of bearings. A rotatable screw shaft requires two bearings per shaft—one at each end—while a rotatable nut requires only one bearing. The present invention provides a mechanism for a telescoping linear actuator that maximizes the extended-to-retracted ratio, payload capacity, energy efficiency, reliability, and safety, while minimizing cost and noise.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A telescoping linear actuator, comprising:
an outer telescoping section;
an intermediate telescoping section slidably nested in the outer telescoping section;
an inner telescoping section slidably nested in the intermediate telescoping section;
an actuator housing comprising a housing base attached to a bottom end of the intermediate section and an upper support plate supported proximate an upper end of the intermediate section by a support extending from the housing base;
a motor mounted in the actuator housing;
a first screw drive comprising a first screw drive nut rotatably mounted on the housing base and a first screw shaft having a bottom end mounted non-rotatably to a bottom plate of the outer telescoping section, the first screw shaft threaded through the first screw drive nut;
a second screw drive comprising a second screw drive nut rotatably mounted on the upper support plate of the actuator housing and a second screw shaft having a top end mounted non-rotatably to a top plate of the inner telescoping section, the second screw shaft threaded through the second screw drive nut; and
an idler shaft mounted rotatably in the actuator housing and extending between the first and second screw drive nuts, wherein the idler shaft is driven to rotate by the motor, and the idler shaft drives both the first and second screw drive nuts to rotate;
wherein rotating the idler shaft in a first direction translates the first and second screw shafts in opposite directions relative to the intermediate telescoping section, translating the outer telescoping section and the inner telescoping section in opposite directions relative to the intermediate telescoping section.

2. The telescoping linear actuator of claim 1, further comprising:
a brake drum driven by the idler shaft for co-rotation therewith;
a brake spring coiled circumferentially around a cylindrical surface of the brake drum, the brake spring comprising a first end fixed to the housing and a second end free to follow the cylindrical surface of the brake drum;
wherein when the idler shaft rotates to extend the actuator, the cylindrical surface of the brake drum rotates circumferentially away from the second end of the spring and toward the first end thereof, loosening engagement of the brake spring on the brake drum; and
wherein when the idler shaft rotates to retract the actuator, the brake spring grabs the cylindrical surface of the brake drum, preventing said retraction.

3. The telescoping linear actuator of claim 2, further comprising:
a brake release linkage that pulls the second end of the brake spring away from the first end, releasing the engagement of the brake spring on the brake drum.

4. The telescoping linear actuator of claim 3, wherein the brake release linkage is actuated by a solenoid mounted on the actuator housing to release the grip of the brake spring from the brake drum when the motor is powered to retract the actuator, and wherein the solenoid defaults to a non-release braking condition during a power failure.

5. The telescoping linear actuator of claim 1, wherein the idler shaft drives both the first and second screw drive nuts to rotate in a same direction via first and second pulleys on the idler shaft driving respective pulleys on the first and second drive nuts through respective drive belts, wherein one of the screw drives is left-handed and the other of the screw drives is right-handed, wherein turning the first and second screw drive nuts in the same direction translates the first and second screw shafts in opposite directions, moving the inner and outer telescoping sections in opposite directions relative to the intermediate telescoping section.

6. The telescoping linear actuator of claim 5, wherein the motor drives the idler shaft by a pulley on the motor driving a third pulley on the idler shaft via a drive belt.

7. The telescoping linear actuator of claim 1, further comprising an electrical circuit that selectively short circuits the motor through a resistor when power to the motor is off, such that the motor forms a regenerative brake that resists turning of the idler shaft when the motor is unpowered.

8. The telescoping linear actuator of claim 2, further comprising an electrical circuit that selectively short circuits the motor through a resistor when power to the motor is off, such that the motor forms a regenerative brake that resists turning of the idler shaft when the motor is unpowered.

9. The telescoping linear actuator of claim 1, wherein each of the telescoping sections is tubular, and the inner telescoping section slides over the actuator housing within the intermediate section during the retraction of the actuator.

10. A telescoping linear actuator, comprising:
three nested telescoping sections that telescopically extend and retract actuated by first and second internal screw drives comprising respective first and second screw drive nuts rotatably mounted at opposite ends of an intermediate one of the telescoping sections, and respective first and second screw shafts non-rotatably mounted to respective distal ends of outer and inner ones of the telescoping sections, wherein the two drive nuts are driven by a motor mounted in the intermediate section.

11. The telescoping linear actuator of claim 10, wherein one of the screw drives is left-handed and the other of the screw drives is right-handed, wherein turning both drive nuts in the same direction linearly translates the screw shafts in opposite directions, forcing the outer and inner telescoping sections in opposite directions relative to the intermediate section.

12. The telescoping linear actuator of claim 11, further comprising an actuator housing within the intermediate section, the actuator housing comprising a housing base attached to a bottom end of the intermediate section and an upper support plate that is supported by supports extending from the housing base;
wherein the first screw drive nut is rotatably mounted on the housing base, and a bottom end of the first screw shaft is mounted non-rotatably to the outer telescoping section; and
wherein the second screw drive nut is rotatably mounted on the upper support plate, and a top end of the second screw shaft is mounted non-rotatably to the inner telescoping section.

13. The telescoping linear actuator of claim 12, further comprising:
an idler shaft mounted rotatably in the actuator housing and extending between the first and second screw drive nuts, wherein the motor drives the idler shaft, and the idler shaft drives the first and second screw drive nuts;
wherein rotating the idler shaft in a first direction forcibly translates the first and second screw shafts in opposite directions relative to the intermediate section, extending the outer section and the inner section in opposite directions relative to the intermediate section.

14. The telescoping linear actuator of claim 13, wherein the motor drives the idler shaft by a first pulley belt drive, and the idler shaft drives the first and second drive nuts by second and third pulley belt drives.

15. The telescoping linear actuator of claim 13, further comprising:
a brake drum fixed to the idler shaft for co-rotation therewith;
a brake spring coiled circumferentially around a cylindrical surface of the brake drum, the brake spring comprising a first end fixed to the actuator housing and a second end free to follow the cylindrical surface of the brake drum;
wherein when the idler shaft rotates to extend the actuator, the cylindrical surface of the brake drum rotates the second end of the brake spring toward the first end thereof, loosening the brake spring on the brake drum; and
wherein when the idler shaft rotates to retract the actuator, the cylindrical surface of the brake drum rotates the second end of the brake spring away from the first end thereof, tightening the brake spring on the brake drum and preventing said retraction.

16. The telescoping linear actuator of claim 15, further comprising:
a brake release linkage that selectively pulls the second end of the brake spring toward the first end, releasing the brake spring from the brake drum.

17. The telescoping linear actuator of claim 16, wherein the brake release linkage is electrically actuated to release the brake spring from the brake drum when the motor is powered to retract the actuator, and the brake release linkage defaults to a non-release braking condition of the brake spring during a power failure.

18. The telescoping linear actuator of claim 15, further comprising an electrical circuit that selectively disconnects a power supply from the motor and connects a resistor between power leads of the motor, wherein the motor then operates as a regenerative resistance brake that resists rotation of the idler shaft.

19. A telescoping linear actuator comprising:
an outer telescoping section;
an intermediate telescoping section slidably nested in the outer section;
an inner telescoping section slidably nested in the intermediate section;
first and second screw shafts fixed to respective distal ends of the outer and inner telescoping sections;
first and second screw drive nuts rotatably mounted at opposite ends of the intermediate telescoping section to linearly translate the first and second screw shafts in opposite directions; and
a motor for driving an idler shaft in the intermediate section, with the idler shaft spanning between and driving the first and second screw drive nuts.

20. The telescoping linear actuator of claim 19, further comprising:
a resistor selectively connectable between power leads of the motor such that the motor operates as a regenerative resistance brake when drive power to the motor is off; and
a mechanical brake on the idler shaft that defaults to a braking condition when drive power to the motor is off.
